(19) United States
(12) Patent Application Publication
(10) Pub. No.: US 2018/0275812 A1
(43) Pub. Date: Sep. 27, 2018

(54) SPLIT TOUCH DEVICE, TOUCH SCREEN DATA TRANSMISSION SYSTEM AND METHOD

(71) Applicants: HONGFUJIN PRECISION ELECTRONICS(CHONGQING)CO. LTD, Chongqing (CN); HON HAI PRECISION INDUSTRY CO., LTD., New Taipei (TW)

(72) Inventors: KO-YI LEE, New Taipei (TW); HSIN-TE YU, New Taipei (TW); QIU-HUANG CHEN, New Taipei (TW); YUAN-CHIEH TSAI, New Taipei (TW)

(21) Appl. No.: 15/475,594

(22) Filed: Mar. 31, 2017

(30) Foreign Application Priority Data
Mar. 22, 2017 (CN) 201710174265.7

(51) Int. Cl. G06F 3/041

(52) U.S. Cl. CPC G06F 3/0416; G06F 3/04886

(57) ABSTRACT

A touch screen data transmission system enabling a single touch screen to communicate with and command a plurality of hosts includes a dividing module, an obtaining module, a determining module, a converting module, and a transmitting module. The dividing module divides the touch screen into a plurality of touch areas which each have own start and end coordinates and each touch area is relevant to one host of the plurality. The obtaining module obtains a coordinate of a touch point and determining module determines the relevant touch area. The converting module converts the coordinate into an area coordinate and the transmitting module transmits the area coordinate to relevant host to open that host for communicating and commanding purposes. A touch screen data transmission method and a split touch device are also provided.

### FIELD

The subject matter herein generally relates to touch screen data transmission system and method.

### BACKGROUND

Touch screens have become increasingly popular because information that is pictorially provided to a user is preferred over hard keyboards or keypads. A touch screen can serve as an input device to communicate with a host (computer host for example). Controlling multiple hosts by a coupled touch screen can be difficult.

### BRIEF DESCRIPTION OF THE DRAWINGS

Implementations of the present technology will now be described, by way of example only, with reference to the attached figures.

FIG. 1 is a diagram of an exemplary embodiment of a touch screen data transmission system.

FIG. 2 is a block diagram of an exemplary embodiment of the touch screen data transmission system of FIG. 1.

FIG. 3 is a diagram of an exemplary embodiment of a touch screen in a split screen state.

FIG. 4 is a block diagram of an exemplary embodiment of a touch device.

FIG. 5 is a flow diagram of an exemplary embodiment of a touch screen data transmission method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

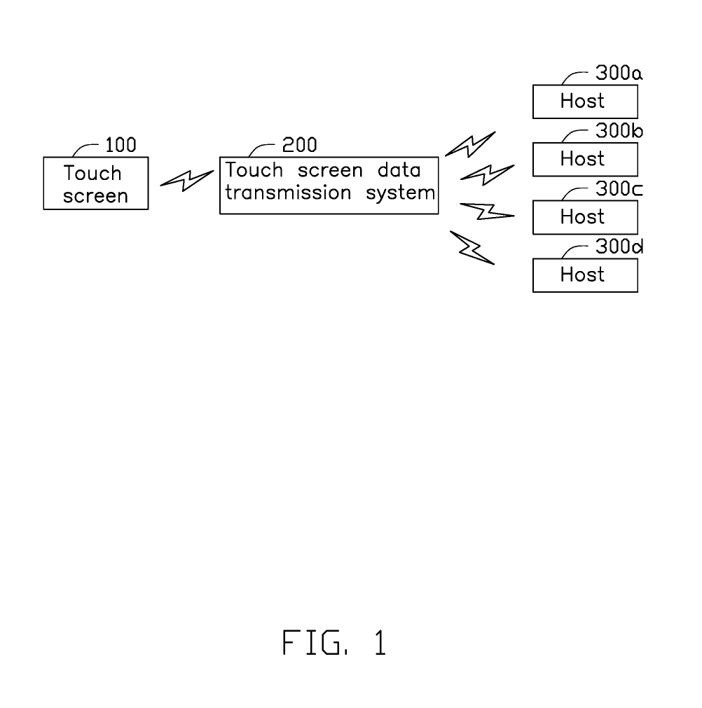

FIG. 1 illustrates a touch screen data transmission system 200 in accordance with an exemplary embodiment.

The touch screen data transmission system 200 is configured to communicate with a touch screen 100 and a plurality of hosts. Each of the hosts can simultaneously use the touch screen 100 to display and the touch screen 100 can control the hosts.

In one exemplary embodiment, the hosts can comprise computer hosts, television hosts, or server hosts. The plurality of hosts in this exemplary embodiment comprises four hosts, 300a to 300d. When the touch screen 100 communicates with a plurality of television hosts through the touch screen data transmission system 200, the touch screen 100, the touch screen data transmission system 200, and the plurality of television hosts can form a plurality of independent televisions.

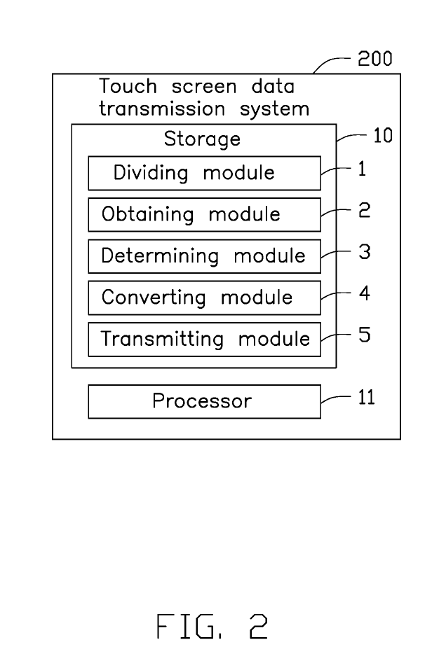

Referring to FIG. 2, the touch screen data transmission system 200 can comprise at least one storage 10 and at least one processor 11. The touch screen data transmission system 200 can further include a plurality of modules, such as a dividing module 1, an obtaining module 2, a determining module 3, a converting module 4, and a transmitting module 5. The modules 1-5 can include one or more software programs in the form of computerized codes stored in the storage 10. The computerized codes can include instructions that can be executed by the processor 11 to provide functions for the modules 1-5.

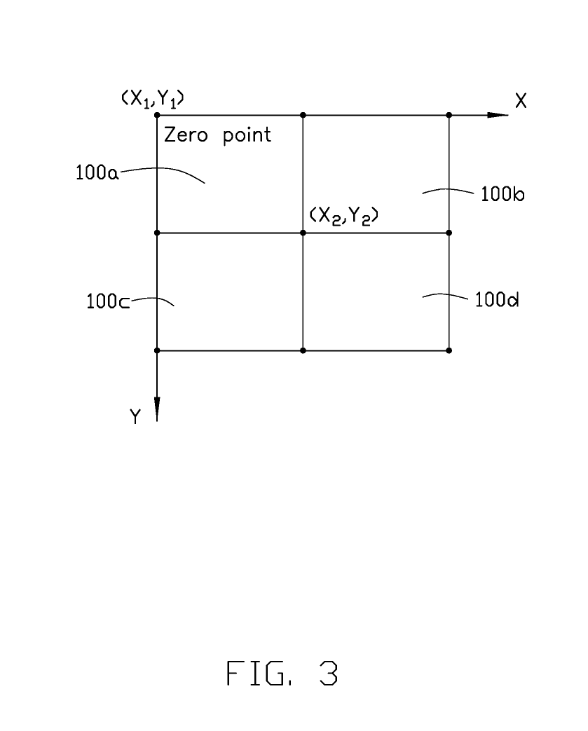

The dividing module 1 is configured to divide a touch screen 100 into a plurality of touch areas and define a starting coordinate and an ending coordinate to each of the touch areas. Each of the touch areas defines a coordinate system. A starting coordinate of a touch area is a touch point coordinate that has a minimum horizontal coordinate and a minimum vertical coordinate (zero point), and an ending coordinate of the touch area is a touch point coordinate that has a maximum horizontal coordinate (greater than zero) and a maximum vertical coordinate (greater than zero). The plurality of touch areas in this exemplary embodiment comprises four touch areas, 100a to 100d, as shown in FIG. 3. The touch area 100a communicates with the host 300a, the touch area 100b communicates with the host 300b, the touch area 100c communicates with the host 300c, and the touch area 100d communicates with the host 300d.

In one exemplary embodiment, a number of the touch areas is equal to a number of the hosts. Then, each of the touch areas can correspond to each of the hosts. The dividing module 1 can divide the touch screen 100 into four touch areas 100a to 100d and define the starting coordinate and the ending coordinate to each of the touch areas 100a to 100d through a four-quadrant rule. The dividing module 1 also can divide the touch screen 100 into four touch areas 100a to 100d and define the starting coordinate and the ending coordinate to each of the touch areas 100a to 100d through other coordinate rules. Each of the touch areas 100a to 100d has the same size.

The obtaining module 2 is configured to obtain a coordinate of a touch point when the touch screen 100 is touched. The determining module 3 is configured to determine the touch area to which the touch point belongs. The converting module 4 is configured to convert the coordinate of the touch point into an area coordinate, according to the starting coordinate and the ending coordinate of a first touch area. If the touch point is determined to belong to the first touch area for example. The transmitting module 5 is configured to transmit the area coordinate to a first host. The first host corresponds to the first touch area.

The touch screen 100 also defines a coordinate system, the determining module 3 can determine the touch area to which the touch point belongs according to the coordinate system of the touch screen 100. When the determining module 3 determines that the coordinate of the touch point to belong to the touch area 100a, the converting module 4 converts the coordinate of the touch point into the area coordinate according to the starting coordinate and the ending coordinate of the touch area 100a, and the transmitting module 5 transmits the area coordinate to the host 300a. Then, the host 300a can receive a touch command from the touch area 100a and communicate with the touch area 100a.

For example, the touch screen 100 comprises a first coordinate system, and the first coordinate system is configured to identify a location of the touch point. Each of the touch areas 100a to 100d also define a second coordinate system. When each of the touch areas 100a to 100d is coupled to a respective host (of the hosts 300a to 300d), each of the touch areas 100a to 100d can display in full screen.

In one exemplary embodiment, the touch areas 100a to 100d can comprise different coordinate systems. The converting module can convert the coordinate of the touch point into the area coordinate through a partition algorithm.

In one exemplary embodiment, the touch screen 100 comprises a first operation mode and a second operation mode. When the touch screen 100 is in the first operation mode, the touch screen 100 operates as a single touchable area. When the touch screen 100 is in the second operation mode, the touch screen 100 operates as the plurality of touch areas 100a to 100d.

Referring to FIG. 3, the dividing module 1 divides the touch screen 100 into four touch areas 100a to 100d, and the four touch areas 100a to 100d have the same size. The upper left of the touch screen 100 represents touch area 100a, the lower left of the touch screen 100 represents touch area 100c, the upper right of the touch screen 100 represents touch area 100b, and the lower right of the touch screen 100 represents touch area 100d. A coordinate of an upper left corner point of each of the touch areas 100a to 100d is the starting coordinate of each of the touch areas 100a to 100d, and a coordinate of a lower right corner point of each of the touch areas 100a to 100d is the ending coordinate of each of the touch areas 100a to 100d.

For example, a first coordinate (X1, Y1) is the starting coordinate of the touch area 100a, and a second coordinate (X2, Y2) is the ending coordinate of the touch area 100a. Each of the touch areas 100a to 100d can be rectangular. A starting coordinate of a touch area is a touch point coordinate that has a minimum horizontal coordinate and a minimum vertical coordinate, and an ending coordinate of the touch area is a touch point coordinate that has a maximum horizontal coordinate and a maximum vertical coordinate.

In one exemplary embodiment, the first coordinate (X1, Y1) is the zero point of the touch area 100a, X1 is less than X2, and Y1 is less than Y2.

In one exemplary embodiment, the determining module 3 determines that the touch point belongs to the touch area 100a if the coordinate of the touch point meets the following four conditions (expressed as two pairs of conditions): (1) a horizontal coordinate of the touch point is greater than a horizontal coordinate of starting point of the touch area 100a but less than a horizontal coordinate of ending point of the touch area 100a; (2) a vertical coordinate of the touch point is greater than a vertical coordinate of the starting point of the touch area 100a but less than a vertical coordinate of the ending point of the touch area 100a.

Configurations and features of the touch areas 100b, 100c, and 100d are substantially the same as for those of the touch area 100a.

In one exemplary embodiment, the touch screen data transmission system 200 can operate as an independent device and be coupled to the touch screen 100. The touch screen data transmission system 200 also can combine with the touch screen 100 to form a touch device.

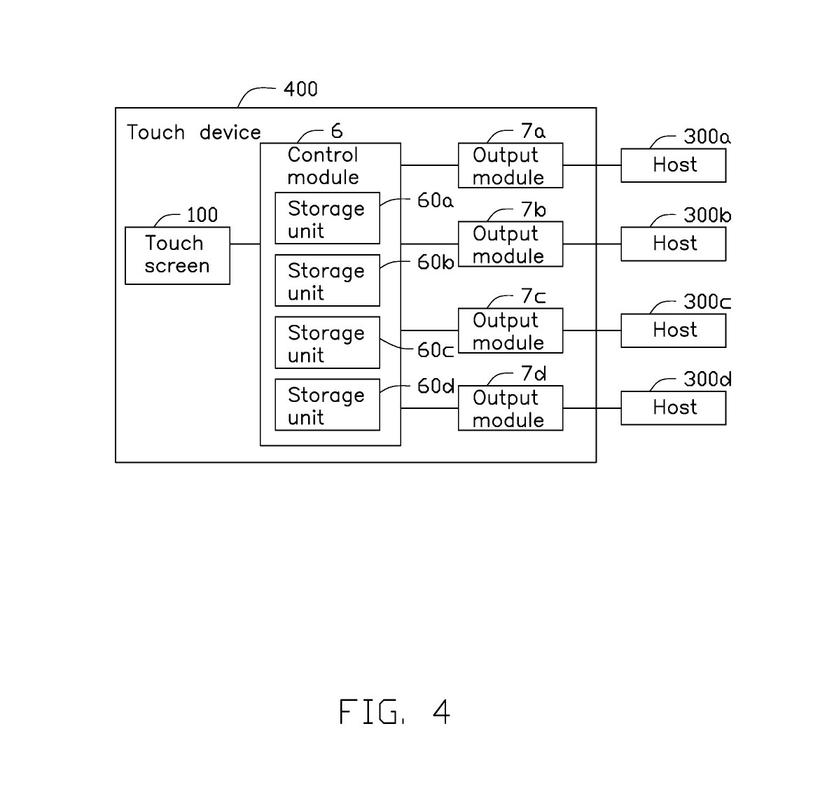

FIG. 4 illustrates a touch device 400 in accordance with an exemplary embodiment. The touch device 400 is coupled to the plurality of hosts 300a to 300d. The touch device 400 comprises the touch screen 100, a control module 6, and a plurality of output modules 7a to 7d.

In one exemplary embodiment, each output module (of 7a to 7d) corresponds to one of the touch areas 100a to 100d and one of the hosts 300a to 300d. The plurality of output modules in this exemplary embodiment comprises four output modules.

The control module 6 is coupled to the touch screen 100. When the control module 6 receives a split screen signal, the control module 6 divides the touch screen 100 into the plurality of touch areas 100a to 100d and defines the starting coordinate and the ending coordinate to each of the touch areas 100a to 100d. The control module 6 can control the touch screen 100 in the first operation mode or in the second operation mode.

When the touch screen 100 is touched, the control module 6 obtains a coordinate of a touch point and determines the touch area to which the touch point belongs. The output modules 7a to 7d are coupled to the control module, and the output modules 7a to 7d are respectively coupled to the hosts 300a to 300d. The control module 6 further transmits the coordinate of the touch point to an output module in response to determining that the coordinate of the touch point belongs to one of the touch areas 100a to 100d. The output module converts the coordinate of the touch point into an area coordinate according to the starting coordinate and the ending coordinate of the touch area, and outputs the area coordinate to the relevant one of the hosts 300a to 300d.

For example, when the control module 6 determines that the coordinate of the touch point belongs to the touch area 100a, the control module 6 transmits the coordinate of the touch point to the output module 7a. The output module 7a converts the coordinate of the touch point into the area coordinate according to the starting coordinate and the ending coordinate of the touch area 100a, and transmits the area coordinate to the host 300a. Then, the host 300a can communicate with the touch area 100a.

In one exemplary embodiment, the control module 6 can be a microcontroller unit (MCU) chip, an acorn risc machine (ARM) processor, or a single-chip for example. Each of the output modules 7a to 7d can be an MCU, an ARM processor, or a single-chip device.

In one exemplary embodiment, the control module 6 comprises a plurality of storage units. Each of the storage units corresponds to one touch area of the touch areas 100a to 100d. The plurality of storage units in this exemplary embodiment comprises four storage units, 60a to 60d. The control module 6 is further configured to store data received from the touch area 100a into the storage unit 60a for example. The control module 6 stores data received from the touch area 100d into the storage unit 60d for example.

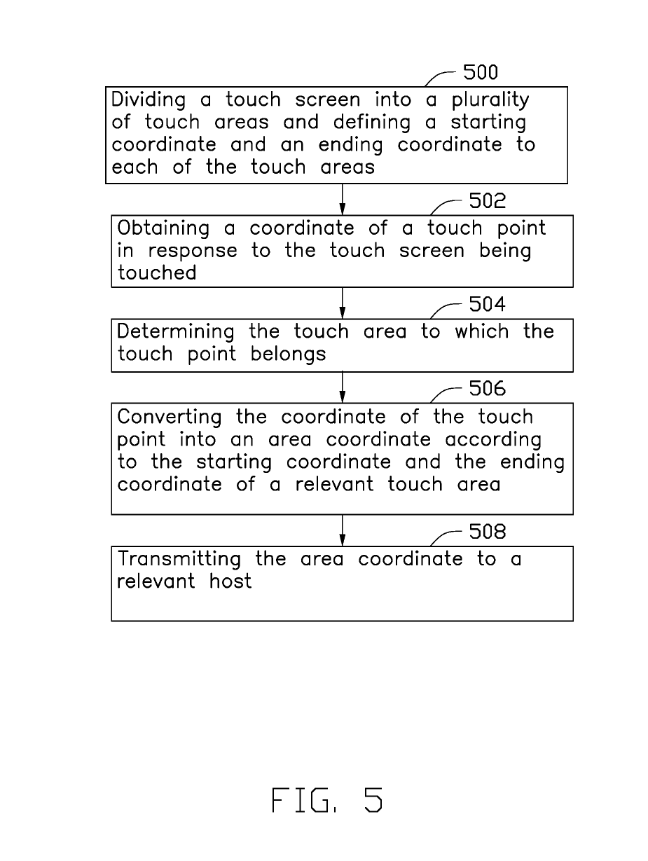

FIG. 5 illustrates one exemplary embodiment of a touch screen data transmission method. The flowchart presents an example embodiment of the method. The example method is provided by way of example, as there are a variety of ways to carry out the method. The method described below can be carried out using the configurations illustrated in FIG. 2, for example, and various elements of these figures are referenced in explaining the example method. Each step shown in FIG. 5 represents one or more processes, methods, or subroutines, carried out in the example method. Furthermore, the illustrated order of steps is illustrative only and the order of the steps can change. Additional steps can be added or fewer steps may be utilized, without departing from this disclosure. The example method can begin at step 500.

In step 500, the dividing module 1 divides the touch screen 100 into the plurality of touch areas 100a to 100d and define a starting coordinate and an ending coordinate to each of the touch areas 100a to 100d.

In step 502, the obtaining module 2 obtains a coordinate of a touch point in response to the touch screen 100 being touched.

In step 504, the determining module 3 determines the touch area to which the touch point belongs.

In step 506, the converting module 4 converts the coordinate of the touch point into an area coordinate according to the starting coordinate and the ending coordinate of a first touch area. If the touch point is determined to belong to the first touch area for example.

In step 508, the transmitting module 5 transmits the area coordinate to a first host. The first host is coupled to the first touch area.

For example, when the determining module 3 determines the coordinate of the touch point to belong to the touch area 100a. The converting module 4 converts the coordinate of the touch point into the area coordinate according to the starting coordinate and the ending coordinate of the touch area 100a, and the transmitting module 5 transmits the area coordinate to the host 300a.

In one exemplary embodiment, the determining module 3 determines the touch point to belong to the touch area 100a if the coordinate of the touch point matches following four conditions (expressed as two pairs of conditions): (1) a horizontal coordinate of the touch point is greater than a horizontal coordinate of starting point of the touch area 100a but less than a horizontal coordinate of ending point of the touch area 100a; (2) a vertical coordinate of the touch point is greater than a vertical coordinate of the starting point of the touch area 100a but less than a vertical coordinate of the ending point of the touch area 100a.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

1. A touch screen data transmission method comprising:
dividing a touch screen into a plurality of touch areas and defining a starting coordinate and an ending coordinate to each of the touch areas;
obtaining a coordinate of a touch point in response to the touch screen being touched;
determining the touch area to which the touch point belongs;
converting the coordinate of the touch point into an area coordinate according to the starting coordinate and the ending coordinate of a relevant touch area; and
transmitting the area coordinate to a relevant host;
wherein the touch areas are respectively coupled to a plurality of hosts; and
wherein the touch screen comprises a first operation mode and a second operation mode; when the touch screen is in the first operation mode, the touch screen operates as a single touchable area and only displays images provided by one host and when the touch screen is in the second operation mode, the touch screen operates as the plurality of touch areas and displays images provided by the plurality of hosts.

2. The touch screen data transmission method of claim 1, wherein each of the touch areas has the same size.

3. The touch screen data transmission method of claim 1, wherein each of the touch areas comprises a plurality of touch points; the starting coordinate is a touch point coordinate that has a minimum horizontal coordinate and a minimum vertical coordinate; and the ending coordinate is a touch point coordinate that has a maximum horizontal coordinate and a maximum vertical coordinate.

4. The touch screen data transmission method of claim 1, wherein the step of determining the coordinate of the touch point to belong to which touch area comprises:
determining the touch point to belong to the first touch area in response to the coordinate of the touch point meeting the four below conditions:
a horizontal coordinate of the touch point being greater than a horizontal coordinate of a first touch area starting point;
the horizontal coordinate of the touch point being less than a horizontal coordinate of a first touch area ending point;
a vertical coordinate of the touch point being greater than a vertical coordinate of the first touch area starting point; and
the vertical coordinate of the touch point being less than a vertical coordinate of the first touch area ending point.

5. (canceled)

6. A touch screen data transmission system for communicating with a touch screen and a plurality of hosts comprising:
at least one storage configured to store a plurality of modules, being a collection of instructions of an application operable in the system; and
at least one processor configured to execute the plurality of modules, the modules comprising:
a dividing module configured to divide the touch screen into a plurality of touch areas and define a starting coordinate and an ending coordinate to each of the touch areas;
an obtaining module configured to obtain a coordinate of a touch point in response to the touch screen being touched;
a determining module configured to determine the touch area to which the touch point belongs;
a converting module configured to convert the coordinate of the touch point into an area coordinate according to the starting coordinate and the ending coordinate of a relevant touch area; and
a transmitting module configured to transmit the area coordinate to a relevant host;
wherein the touch areas are respectively coupled to a plurality of hosts; and
wherein the touch screen comprises a first operation mode and a second operation mode; when the touch screen is in the first operation mode, the touch screen operates as a single touchable area and only displays images provided by one host; and when the touch screen is in the second operation mode, the touch screen operates as the plurality of touch areas and displays images provided by the plurality of hosts.

7. The touch screen data transmission system of claim 6, wherein each of the touch areas has the same size.

8. The touch screen data transmission system of claim 6, wherein each of the touch areas comprises a plurality of touch points; the starting coordinate is a touch point coordinate that has a minimum horizontal coordinate and a minimum vertical coordinate;
and the ending coordinate is a touch point coordinate that has a maximum horizontal coordinate and a maximum vertical coordinate.

9. The touch screen data transmission system of claim 6, wherein the determining module is configured to determine the touch point to belong to the first touch area in response to the coordinate of the touch point meeting the four below conditions:
a horizontal coordinate of the touch point being greater than a horizontal coordinate of a first touch area starting point;
the horizontal coordinate of the touch point being less than a horizontal coordinate of a first touch area ending point;
a vertical coordinate of the touch point being greater than a vertical coordinate of the first touch area starting point; and
the vertical coordinate of the touch point being less than a vertical coordinate of the first touch area ending point.

10. (canceled)

11. The touch screen data transmission system of claim 9, wherein the converting module converts the coordinate of the touch point into the area coordinate through a partition algorithm.

12. A split touch device comprising:
a touch screen; and
a processor coupled to the touch screen and a plurality of hosts and comprising:
a control module configured to divide the touch screen into a plurality of touch areas according to a control signal and define a starting coordinate and an ending coordinate to each of the touch areas;
the control module further configured to obtain a coordinate of a touch point in response to the touch screen being touched and determine the touch area to which the touch point belongs; and
a plurality of output modules, one of the output modules corresponding to one of the touch areas and one of the hosts;
wherein the control module is further configured to transmit the coordinate of the touch point to a first output module in response to the coordinate of the touch point being determined to belong to a first touch area; the first output module is configured 6to convert the coordinate of the touch point into an area coordinate according to the starting coordinate and the ending coordinate of the first touch area, and output the area coordinate to a first host; and the first output module corresponds to the first touch area and the first host; and
wherein the touch screen comprises a first operation mode and a second operation mode; when the touch screen is in the first operation mode, the touch screen operates as a single touchable area and only displays images provided by one host; and when the touch screen is in the second operation mode, the touch screen operates as the plurality of touch areas and displays images provided by the plurality of hosts.

13. The split touch device of claim 12, wherein each of the touch areas has the same size.

14. The split touch device of claim 12, wherein each of the touch areas comprises a plurality of touch points; the starting coordinate is a touch point coordinate that has a minimum horizontal coordinate and a minimum vertical coordinate; and the ending coordinate is a touch point coordinate that has a maximum horizontal coordinate and a maximum vertical coordinate.

15. The split touch device of claim 12, wherein the control module is configured to determine the touch point to belong to the first touch area in response to the coordinate of the touch point meeting the four below conditions:
a horizontal coordinate of the touch point being greater than a horizontal coordinate of a first touch area starting point;
the horizontal coordinate of the touch point being less than a horizontal coordinate of a first touch area ending point;
a vertical coordinate of the touch point being greater than a vertical coordinate of the first touch area starting point; and
the vertical coordinate of the touch point being less than a vertical coordinate of the first touch area ending point.

16. (canceled)

17. The split touch device of claim 12, wherein when the control module does not receive the control signal, the control module controls the touch screen to operate in the first operation mode; and when the control module receives the control signal, the control module controls the touch screen to operate in the second operation mode.

18. The split touch device of claim 12, wherein a number of the output modules is equal to a number of the touch areas and a number of the hosts.

19. The split touch device of claim 12, wherein the processor further comprises a plurality of storage units; one of the storage units corresponds to one of the touch areas; the control module is further configured to store data received from the first touch area into a first storage unit; and the first storage unit corresponds to the first touch area.
